(19) United States
(12) Patent Application Publication
(10) Pub. No.: US 2024/0120757 A1
(43) Pub. Date: Apr. 11, 2024

(54) STACKING BRACKET FOR AN EXPANSION BATTERY

(71) Applicant: Champion Power Equipment, Inc., Santa Fe Springs, CA (US)

(72) Inventors: Greg Pauken, Hartland, WI (US); James J. Dehn, Brookfield, WI (US); Zhikun Zhong, New Berlin, WI (US); Artur Starosciak, Greendale, WI (US)

(21) Appl. No.: 18/481,151

(22) Filed: Oct. 4, 2023

Related U.S. Application Data
(60) Provisional application No. 63/378,448, filed on Oct. 5, 2022.

(51) Int. Cl. H02J 7/00; H01M 50/251; H01M 50/256

(52) U.S. Cl. CPC H02J 7/0045; H01M 50/251; H01M 50/256; H02J 7/0013; H02J 7/0063; H01M 2220/10; H02J 2207/20

(57) ABSTRACT

A stacking adaptor for power station expansion batteries includes a main body having an upper surface and a lower surface. At least one cutout is formed in the lower surface of the main body and is configured to receive a handle of a first power station expansion battery. At least one opening is formed in the upper surface of the main body and is configured to seat a second power station expansion battery thereon.

### CROSS-REFERENCE TO RELATED APPLICATIONS

The present application is a non-provisional of and claims priority to U.S. Provisional Patent Application Ser. No. 63/378,448, filed Oct. 5, 2022, the disclosure of which is incorporated herein by reference in its entirety.

### BACKGROUND OF THE INVENTION

Embodiments of the present invention relate to gasless inverter generators or power stations and, more particularly, to a system for increasing energy capacity available to an electrical load by connecting a power station to at least one additional power source stacked thereon.

Fuel generators powered by fossil fuels, such as, for example, gasoline, liquefied petroleum gas (LPG), or natural gas (NG), are commonly used as a mobile or backup power source. Fuel generators can provide power in locations without access to the utility grid or when natural disasters, extreme weather events, or other conditions result in a power outage. Fuel generators require a constant supply of fuel for combustion, and that fuel might not be readily available, particularly in remote locations and when natural disasters or severe weather interrupts the fuel supply. Further, these types of generators contribute to global warming, require frequent maintenance, and emit hazardous exhaust and noise, which makes them unsuitable for indoor environments.

Inverter power stations include battery systems that can store electrical energy for use in locations without access to the utility grid or when a power outage occurs in the grid. Inverter power station users can charge these battery systems with energy from various sources such as, for example, the utility grid using a converter or rectifier that changes alternating current (“AC”) power into direct current (“DC”) power. Alternatively, such users may elect to charge their battery systems with energy from carbon-free renewable energy sources, the use of which generally reduces dependence on fossil fuels and lowers energy bills. As an example, solar panels can charge battery systems to provide a renewable source of stored energy independent from the utility grid, which is convenient for many mobile and off-grid applications. Battery systems can include batteries connected in series or in parallel to expand capacity in terms of voltage and/or current and can power electrical devices that require AC power using an inverter that transforms DC power into AC power.

Portable inverter power stations often have a small size that allows them to be transportable. The size of these portable power stations can determine the space available for onboard battery systems and associated power electronics used to power electrical loads connected to the power stations. As a result, the energy capacity of a power station is often limited due to the portable nature of the power station. Unfortunately, a larger power station that includes a larger energy capacity can be hard to transport, requires a larger footprint, and can be more costly. In addition, buying multiple portable inverter power stations is not typically desirable, as this increases the cost for the consumer. Moreover, even when a consumer owns multiple power stations, the consumer may not be able to easily store or use the power stations due to limited space available at a particular location.

Therefore, it would be desirable to provide a portable gasless inverter generator or power station powered by an expandable battery system that can couple to at least one additional power source to increase the energy capacity available to a load, with the additional power source being stackable with the power station.

### BRIEF STATEMENT OF THE INVENTION

Embodiments of the present invention relate to a stacking adaptor for expansion batteries configured to provide an increased battery level to a power station and to be arranged in a stacked configuration with the power station.

In accordance with one aspect of the invention, a stacking adaptor for power station expansion batteries incudes a main body having an upper surface and a lower surface, at least one cutout formed in the lower surface and configured to receive a handle of a first power station expansion battery, and at least one opening formed in the upper surface and configured to seat a second power station expansion battery thereon.

In accordance with another aspect of the invention, a power station assembly includes an inverter power station and first and second power station expansion batteries. Each of the first and second power station expansion batteries is configured to stack on the inverter power station and includes at least one handle. The power station assembly additionally includes at least one stacking adaptor configured to enable stacking of the first and second power station expansion batteries. Each stacking adaptor of the at least one stacking adaptor includes a main body. The main body includes a lower surface having at least one cutout configured to fit on each handle of the at least one handle of the first power station expansion battery one and separately fit on each handle of the at least one handle of the second power station expansion battery. The main body further includes an upper surface having at least one opening configured to seat the second power station expansion battery stacked thereon and to separately seat the first power station expansion battery stacked thereon.

In accordance with yet another aspect of the invention, a method of stacking expansion batteries on a power station includes positioning an inverter power station on a surface and stacking a first power station expansion battery on the inverter power station. The first power station expansion battery includes at least one handle. The method also includes positioning a separate stacking adaptor on each handle of the at least one handle of the first power station expansion battery. Each separate stacking adaptor includes a main body having a lower surface with at least one cutout positioned on a respective handle of the at least one handle of the first power station expansion battery and an upper surface with at least one opening configured to seat a second power station expansion battery stacked thereon. Furthermore, the method includes stacking the second power station expansion battery on each separate stacking adaptor.

These and other advantages and features of the present invention will be more readily understood from the following detailed description and the accompanying drawings.

### BRIEF DESCRIPTION OF THE DRAWINGS

The drawings illustrate embodiments presently contemplated for carrying out the invention.

In the drawings:

FIG. 1 is an upper-right front perspective view of a power station, according to an embodiment of the invention.

FIG. 2 is a partial lower-left rear perspective view of the power station of FIG. 1 with power receptacle covers exploded from the power station, according to an embodiment of the invention.

FIG. 3 is a front view of a control panel of the power station of FIG. 1, according to an embodiment of the invention.

FIG. 4 is an upper-right front perspective view of an expansion battery for the power station of FIG. 1, according to an embodiment of the invention.

FIG. 5 is a lower-left rear perspective view of the expansion battery of FIG. 4 with power receptacle covers exploded from the expansion battery, according to an embodiment of the invention.

FIG. 6 is a rear view of the power station of FIG. 1 coupled to first and second expansion batteries of the type shown in FIG. 4, according to an embodiment of the invention.

FIG. 7 is an upper-left perspective view of a stacking adaptor for stacking the expansion battery of FIG. 4 onto another expansion battery of FIG. 4, according to an embodiment of the invention.

FIG. 8 is a lower-right perspective view of the stacking adaptor of FIG. 8, according to an embodiment of the invention.

FIG. 9 is an upper-left front perspective view of a power station assembly including the power station and expansion batteries of FIG. 6 in a stacked configuration with a pair of the stacking adaptors of FIGS. 7 and 8 positioned on handles of the first expansion battery to support the second expansion battery thereon, according to an embodiment of the invention.

FIG. 10 is an upper-right rear perspective view of the power station assembly of FIG. 9 without electrical connections between components, according to an embodiment of the invention.

FIG. 11 is an exploded view of the power station assembly shown in FIG. 9, according to an embodiment of the invention.

### DETAILED DESCRIPTION

The operating environment of the invention is described herein with respect to a portable gasless inverter generator or power station. However, those skilled in the art will appreciate that the invention is equally applicable for use with nonportable power stations. While the invention will be described with respect to a battery-operated power station having an inverter that converts DC power to AC power, embodiments of the invention are equally applicable for use with battery-operated power stations having a DC-to-DC power converter.

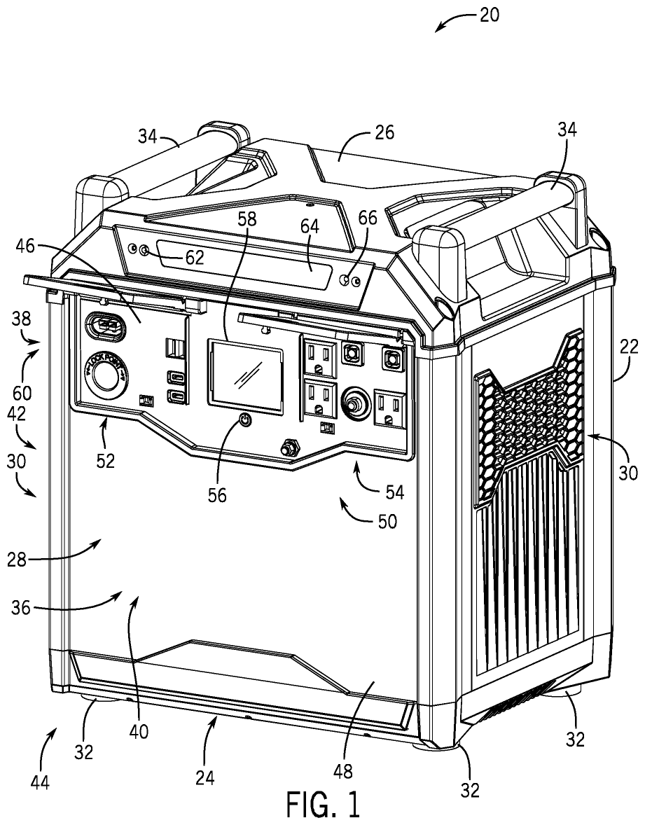

Referring to FIG. 1, an upper-right front perspective view of a portable power station 20 for providing power to electrical devices (not shown in FIG. 1) is shown, according to an embodiment of the invention. The power station 20 includes a housing 22 having a base 24, a top wall or upper surface 26, and a plurality of sidewalls 28 that surround and protect internal components of the power station 20. Cooling vents 30 are positioned in one or more of the sidewalls 28 to provide cooling air to components within the housing 22. The power station 20 may include a plurality of feet 32 extending downward from the base 24 to provide a stable foundation and to raise the housing 22 slightly off of the floor or ground. The power station 20 may include a pair of carrying handles 34 extending upward from the top wall 26 to lift and carry the power station 20. While the carrying handles 34 are shown in FIG. 1 as being oval-shaped, in various embodiments, the carrying handles 34 may have another shape that is comfortable to a user. A single person may be able to lift the power station 20 with one or both of the carrying handles 34, and thus, the power station 20 may act as a convenient mobile power source. Since the carrying handles 34 are also able to support and secure other devices on top of the power station 20, the carrying handles 34 may also be considered supports 34.

The power station 20 typically includes an onboard battery system 36 including one or more batteries (not shown in FIG. 1) and a control system 38 positioned within the housing 22. The onboard battery system 36 may include a rechargeable lithium-ion battery 40 with a chemistry of either nickel manganese cobalt (NMC) or lithium iron phosphate (LFP). The control system 38 may include a converter (not shown in FIG. 1) for converting a voltage from the onboard battery system 36 into another voltage required to operate the electrical devices. The control system 38 may include an inverter 42 to change DC power from the onboard battery system 36 into AC power supplied to the electrical devices. For example, the inverter 42 may provide single or three phase AC power at 50 Hz or 60 Hz. Accordingly, the power station 20 may be referred to as a gasless inverter generator 20.

The power station 20 is shown with a control panel 46 located on a front sidewall 48 of the power station 20. The control panel 46 controls operation of the power station 20 and connects to one or more electrical devices powered by the power station 20. The control panel 46 includes one or more power output receptacles 50 (for example, sockets) that receive electrical connections (for example, plugs) from the electrical devices. The power output receptacles 50 are generally powered by the onboard battery system 36 via the control system 38. The one or more power output receptacles 50 are shown as a plurality of DC power output receptacles 52 and a plurality of AC power output receptacles 54, with the inverter 42 providing AC power to the AC power output receptacles 54.

The control panel 46 includes a power button 56 to turn on and off the power station 20. The power station 20 is turned on/off by the power button 56 when pressed and held for a short period of time. When the power station 20 is on, the power button 56 can also turn the AC power output receptacles 54 on/off when pressed without being held. The control panel 46 may include a display 58, also referred to as a user display panel, to show operating characteristics of the power station 20. The display 58 is typically an automatic display 58 displaying one or more items of information that the control system 38 automatically stores and updates without user input and will be referenced as the automatic display 58 below. However, in some embodiments, the display 58 may also display one or more items of information that control system 38 does not automatically update or may be configured in a manner that requires a manual input from a user for all information updates. In some embodiments, the power button 56 illuminates the automatic display 58 each time it is pressed. The automatic display 58 can display a battery level of the power station 20 to a person using the power station 20. Herein, the battery level of the power station 20 is also referred to as the energy level, charge level, or state of charge of the power station 20. The automatic display 58 may display the battery level in terms of percentages. As such, the battery level is also referenced herein as a percent battery level. The battery level of the onboard battery system 36 may correspond to the battery voltage.

The control system 38 is programmed to determine a THD associated with the AC power from the inverter 42 and to operate the automatic display 58 to indicate the THD to an operator. The automatic display 58 may indicate whether the THD is above a level that could damage sensitive electronic components powered by the inverter 42. High THD is generally caused by a high load on the AC power output receptacles 54 and/or by a low battery level powering the inverter 42. As the battery level drops, the AC power output can be too high for the inverter 42 to simulate a pure sine wave. In various embodiments, the battery level of the onboard battery system 36 corresponds to a voltage output from the battery. Thus, the THD may be determined based on power and voltage output from the power station 20.

The control system 38 may determine the power and voltage output from the power station 20 via measured voltage, current, and/or power values from one or more voltage, current, and/or power sensors (not shown) on the power station 20. Depending on the type of sensor used, the control system 38 may either utilize measured values from the sensors directly or calculate values based on the measured values. Thereafter, the control system 38 may determine the battery level based on the voltage of the onboard battery system 36 and calculate the percent battery level of the onboard battery system 36 at a point in time based on the determined battery level and the battery level capacity of the onboard battery system 36. The THD can therefore be reduced by unplugging one or more AC devices from the power station 20 and/or by charging the onboard battery system 36. If the power output is lower, the inverter 42 will be able to simulate a pure sine wave (for example, a waveform with a low THD) at a lower battery level and for a longer period of time prior to the onboard battery system 36 being recharged.

The control system 38 may be programmed with a THD shield 60 to automatically shut off AC power output from the AC power output receptacles 54 when the THD is above a predetermined level (for example, 5%). The THD shield 60 of the control system 38 may automatically shut off AC power output when the onboard battery system 36 has a battery level below a predetermined battery level, which can indicate that the THD is above a predetermined THD level. In various embodiments, at full AC load (for example, 1,600 Watts (1,600 W)), the THD will rise above 5% at less than 20-25% battery level remaining, and at low loads (for example, 100 W), the THD will not rise above 5% until the onboard battery system 36 is basically dead. Since a charged or partially charged battery might have low THD even at full load, the THD shield 60 could be configured to determine that the battery level of the onboard battery system 36 is lower than a predetermined battery level prior to determining if the THD requires shutting off AC power output. In various embodiments, the predetermined battery level is approximately 30% of a battery level of the onboard battery system 36 when the onboard battery system 36 is at 100% battery level or fully charged and the predetermined THD level is approximately 5%. The DC power output receptacles 52 can remain powered even if the AC power output receptacles 54 are shut off by the THD shield 60.

An overload reset button 62, also referred to as a THD shield button 62, can be pressed to re-energize the DC and AC power output receptacles 52, 54 if they have been shut off due to an electrical fault. The overload reset/THD shield button 62 may also provide a user input control to selectively enable the THD shield 60 while the automatic display 58 indicates whether the THD shield 60 is enabled or disabled. In various embodiments, a user may press the overload reset/THD shield button 62 once to re-energize both AC power output receptacles 54 and DC power output receptacles 52 after an overload fault and five times in three seconds to turn the THD shield 60 on or off. When the THD shield 60 is on and the THD rises above a predetermined level, also referred to as a THD fault level, the control system 38 shuts off AC power output to prevent damage to sensitive electronics. A user may press the overload reset/THD shield button 62 to restore AC power to the AC power output receptacles 54 following a THD shutoff. An LED light 64 that can illuminate a work area in front of the power station 20 is positioned above the control panel 46 adjacent the overload reset button 62 and an LED light button 66 that turns on the LED light 64.

In various embodiments, to restore AC output after the control system 38 shuts off power according to the THD shield 60, a user should charge the power station 20 (if possible), lower the AC running watts by unplugging one or more electrical devices, and press the overload reset button 62 to re-energize the AC power output receptacles 54. In various embodiments, to prevent control system 38 from shutting off power due to the THD shield 60, a user should maintain a high battery level in the onboard battery system 36, charge the power station 20 during use, unplug high current draw AC appliances to lower the AC running watts when the battery falls to near 30% charge capacity, and/or turn off the THD shield 60. In various embodiments, to turn the THD shield 60 off, a user should lower the AC running watts by unplugging one or more devices to limit increasing THD levels as the battery level depletes and press the THD shield button 62 five times within three seconds. When the THD shield 60 is disabled, the control system 38 will not shut off AC power output when the THD rises above the predetermined level. A user should monitor sensitive devices for abnormal operation and disconnect as necessary.

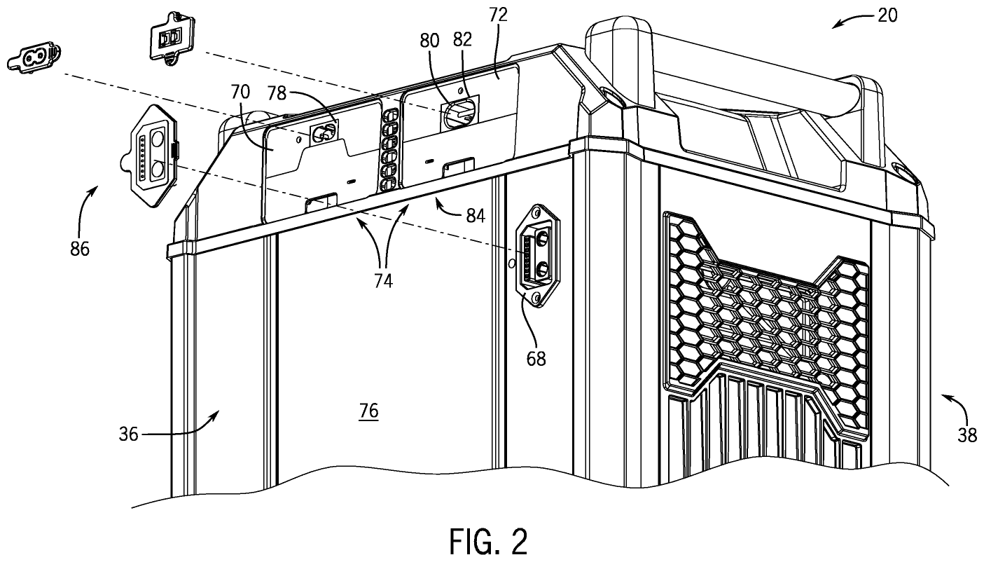

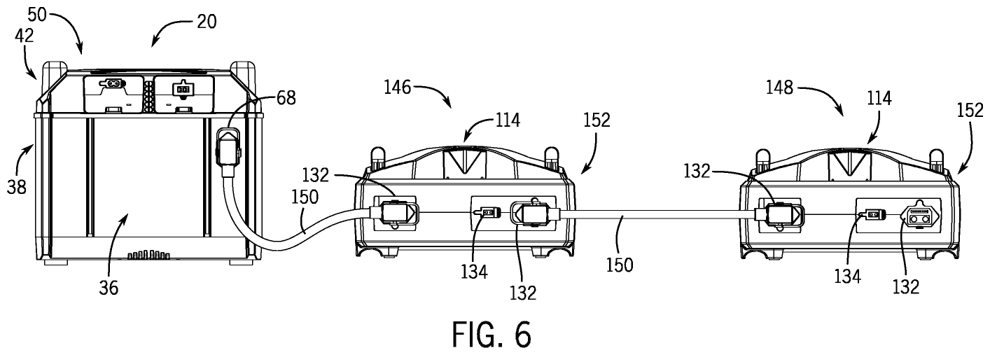

Referring now to FIG. 2, a partial lower-left rear perspective view of the power station 20 is shown with receptacle covers 86 exploded therefrom, according to an embodiment of the invention. The power station 20 includes an external battery port 68 to connect one or more expansion batteries (not shown in FIG. 2), as explained in more detail below with respect to FIG. 6. The power station 20 may couple to a single expansion battery or to a string of expansion batteries (for example, up to ten or more) to increase the battery or energy capacity and runtime of the power station 20. The control system 38 couples the onboard battery system 36 and the external battery port 68 to each of the power output receptacles 50 (FIG. 1).

FIG. 2 shows an AC charging module 70 and a DC charging module 72 that charge the onboard battery system 36 from an AC power source (not shown in FIG. 2) and a DC power source (not shown in FIG. 2), respectively. The AC charging module 70 and the DC charging module 72 are positioned within charging module slots 74 in the rear sidewall 76 of the power station 20. Charging terminals (not shown in FIG. 2) are located within the charging module slots 74 and electrically connect the AC and DC charging modules 70, 72 to the power station 20 when the charging modules 70, 72 are inserted into the charging module slots 74. If a charging module with a different electrical configuration is desired, the AC charging module 70 and the DC charging module 72 can be removed from the charging module slots 74 for replacement.

The AC and DC charging modules 70, 72 have respective AC and DC power inlet receptacles 78, 80 each coupled to the onboard battery system 36 to recharge the power station 20. The AC charging module 70 may include a rectifier (not shown in FIG. 2) to convert AC power from an AC source into DC power supplied to the onboard battery system 36. The AC power inlet receptacle 78 may charge the power station 20 from a traditional wall outlet (not shown in FIG. 2) connected to the utility grid (not shown in FIG. 2). The DC power inlet receptacle 80 may include an APP (Anderson Power Pole) input port 82 that can support DC charging from one or more solar panels (not shown in FIG. 2). The DC charging module 72 may include a maximum power point tracking (MPPT) module 84 to optimize charging of the onboard battery system 36 from the solar panels. The receptacle covers 86 protect the external battery port 68, the AC power inlet receptacle 78, and the DC power inlet receptacle 80 from moisture, dirt, and other debris.

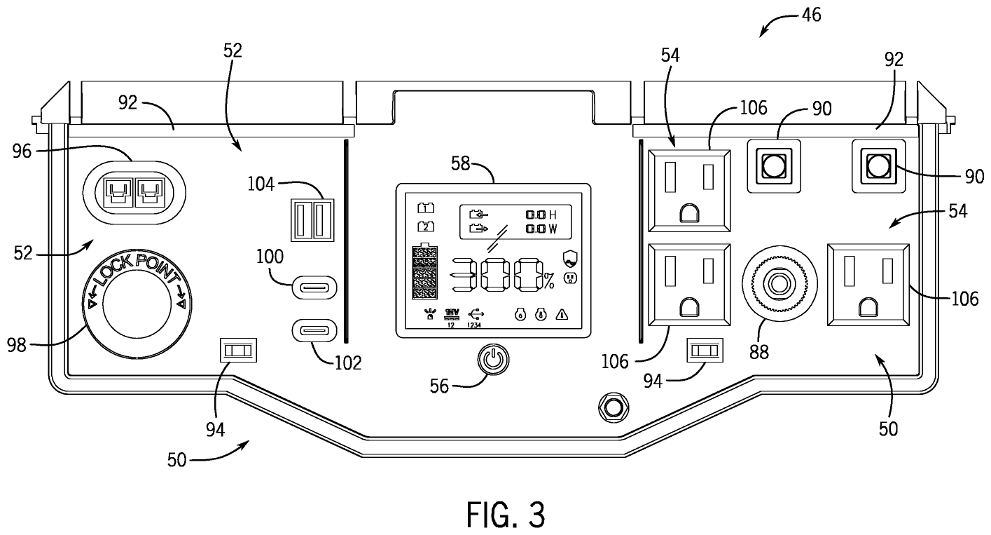

Referring now to FIG. 3, a front view of the control panel 46 of the power station 20 of FIG. 1 is shown, according to an embodiment of the invention. The control panel 46 includes a power button 56 to turn on and off the power station 20 and to illuminate the automatic display 58. The automatic display 58 can indicate the battery level available from the onboard battery system 36 and any connected expansion batteries (not shown in FIG. 3) to a user. The control panel 46 also includes a circuit breaker 88, linking module connection ports or linking kit connection ports 90, and a plurality of selectively openable protective covers 92. The circuit breaker 88 protects the power station 20 against electrical overloads and can be pressed by an operator to reset power to the power output receptacles 50. The linking module connection ports 90 are used to electrically couple AC power outputs from the linking module connection ports 90 of two power stations 20 to a linking kit or module (not shown in FIG. 3) that is able to provide an increased AC power output. The protective covers 92 are hinged to the control panel 46 to selectively cover the power output receptacles 50 and are latched in closed positions by depressible cover locks 94.

The control panel 46 is shown with a plurality of DC power output receptacles 52 that are powered by the onboard battery system 36 and/or any connected expansion batteries (not shown in FIG. 3) and that may output different levels of voltage and current. For example, an APP (Anderson Power Pole) port 96 may supply electrical power for operation of 12-volt (12V) DC, 20-amp (20 A) electrical loads. A regulated automotive port 98 may supply electrical power for operation of 12V DC, 10 A electrical loads. A plurality of Universal Serial Bus (USB) ports may provide power to devices such as, for example, cellphones, laptops, and tablets. A USB Type-C+ Power Delivery (PD) port 100 may supply 5V/9V/12V/15V/20V DC, 3 A Fixed or 3.3V-21V DC according to the Programmable Power Supply (PPS) protocol to provide power up to a maximum of 60 watts (60 W) with PD compatible devices. A USB Type-C+ Quick Charge (QC) port 102 may supply 3.6V-12V DC, 3 A Fixed (for example, 5V/9V, 3 A Fixed or 12V, 2.5 A Fixed) or 3.6V-12V DC PPS to provide power up to a maximum of 30 W with QC 3.0 compatible devices. USB Type-A ports 104 may supply a maximum of 5V DC, 2.1 A.

The control panel 46 is also shown with a plurality of AC power output receptacles 54 that are powered by the onboard battery system 36 and/or any expansion batteries (not shown in FIG. 3). For example, National Electrical Manufacturers Association (NEMA) 5-15R ports 106 may be used to supply electrical power for operation of 120V AC, 15 A, single phase, 60 Hz electrical loads. However, the AC power output receptacles 54 may provide power from the inverter at any suitable current (for example, any integer or half-integer value from 2.5 A to 30 A) and voltage (for example, any integer value from 110V to 120V AC or any integer value from 220V to 250V AC). In various embodiments, the power button 56 turns on the inverter 42 (FIG. 1) to power the AC power output receptacles 54 while the DC power output receptacles 52 are configured to always receive power.

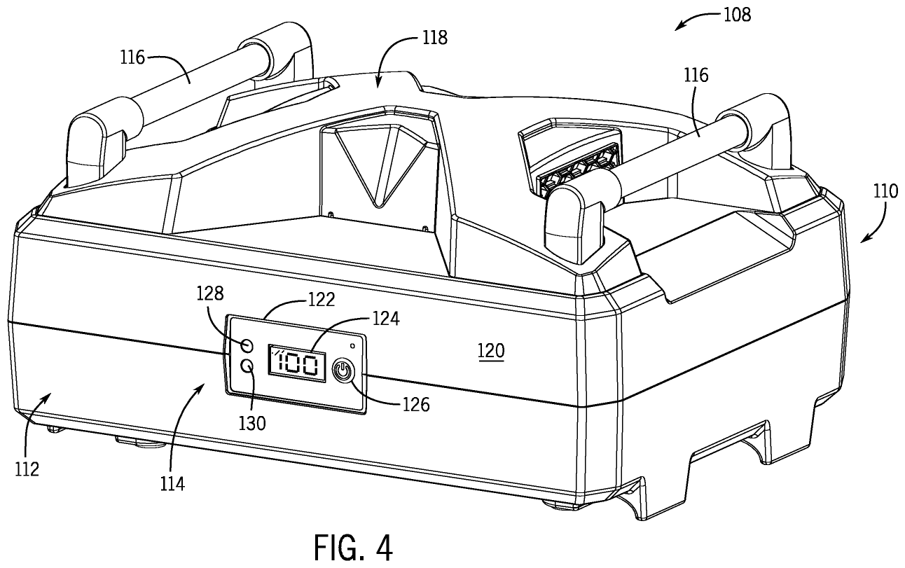

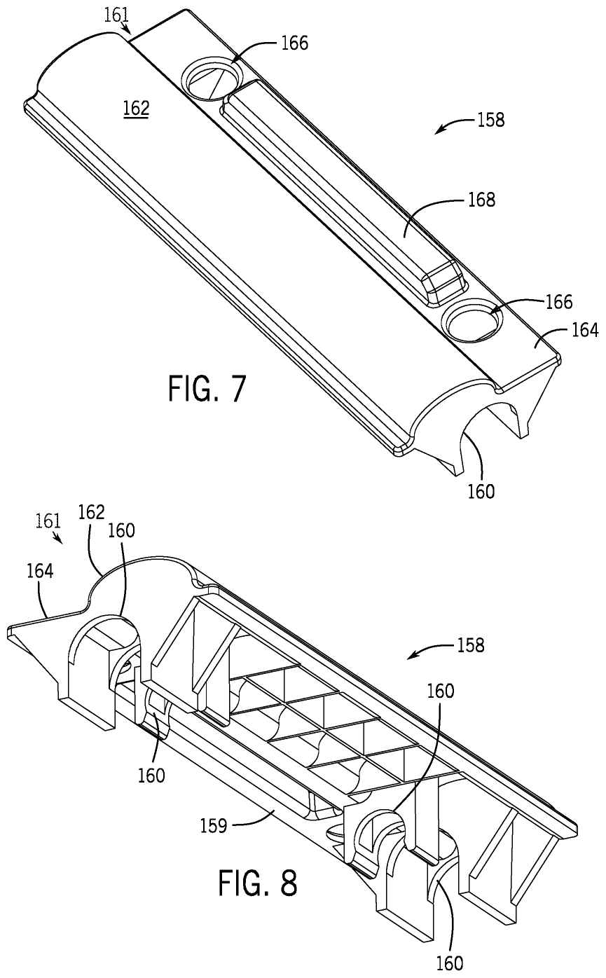

Referring now to FIG. 4, an upper-right front perspective view of an expansion battery 108 for supplying additional power to the power station 20 of FIG. 1 is shown, according to an embodiment of the invention. The expansion battery 108 may include a housing 110 with a battery system 112 including one or more batteries and a control system 114 positioned within the housing. In some embodiments, the battery system 112 is a rechargeable lithium-ion battery with a chemistry of either nickel manganese cobalt (NMC) or lithium iron phosphate (LFP). The control system 114 operates the expansion battery 108 and may include a converter (not shown in FIG. 4) for converting the voltage of battery system 112 into another voltage supplied to the power station 20. A pair of carrying handles 116 extend upward from a top surface 118 of the housing 110 and can be used to lift the expansion battery 108 or to support another expansion battery 108 resting on the handles 116 when in a stacked configuration, as explained in more detail below with respect to FIGS. 7 and 8. Since the carrying handles 116 are also able to support and secure another expansion battery 108 on top of the expansion battery 108, the carrying handles 116 may also be considered supports 116.

A front sidewall 120 of the housing 110 includes a display 122 that shows operating characteristics of the expansion battery 108. The display 122 is generally an automatic display 122 displaying one or more items of information that the control system 114 automatically stores and updates without user input and will be referenced as the automatic display 122 below. However, in some embodiments, the display 122 may also display one or more items of information that the control system 114 does not automatically update or may be configured in a manner that requires a manual input from a user for all information updates. The automatic display 122 includes a fuel or battery gauge 124 that shows a remaining battery level for the expansion battery 108 in terms of percentages. As indicated above with respect to FIG. 1, the remaining battery level may correspond to the battery voltage, and the battery level percentage value is also referenced as a percent battery level. The control system 114 may determine the percent battery level via a measured value from a voltage sensor (not shown) on the expansion battery 108. Depending on the type of voltage sensor, the control system 114 may either utilize measured values from the voltage sensor as voltage values/battery levels or calculate battery levels based on the measured values. Thereafter, the control system 114 may determine the battery level based on the voltage of the battery system 112 and calculate the percent battery level of the battery system 112 at a point in time based on the determined battery level and the battery level capacity of the battery system 112.

The automatic display 122 may also display fault codes when faults occur such as high or low temperature faults, battery or circuitry communication faults, or a battery management system (BMS) fault, as non-limiting examples. A display button 126 turns on/off the automatic display 122 and illuminates the fuel gauge 124. A discharging indicator LED 128 will illuminate red when the automatic display 122 is turned on and the expansion battery 108 is discharging to the power station 20. A charging indicator LED 130 will illuminate green when the automatic display 122 is turned on and the expansion battery 108 is charging.

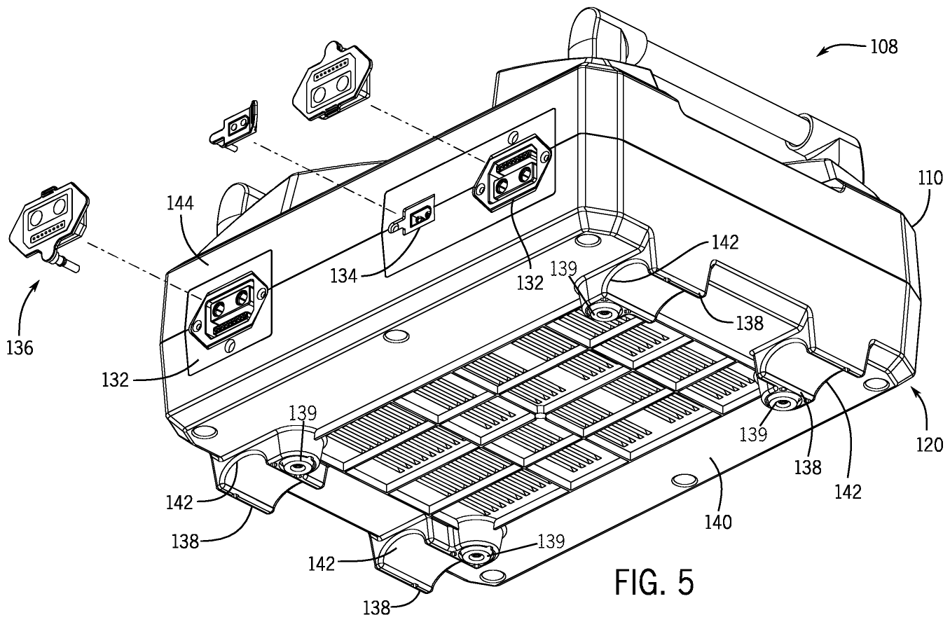

Referring now to FIG. 5, a lower-left rear perspective view of the expansion battery 108 is shown with receptacle covers 136 exploded therefrom, according to an embodiment of the invention. The expansion battery 108 includes a pair of battery connection ports 132. Each of the battery connection ports 132 connect the expansion battery 108 to the power station 20 or to another expansion battery 108. The expansion battery also includes a charging module input port 134 configured to connect to a power cord of a charging module (not shown in FIG. 5) that is configured to charge the expansion battery 108. The receptacle covers 136 protect the battery connection ports 132 and the charging module input port 134 from moisture, dirt, and other debris.

The expansion battery 108 generally includes four feet 138 extending downward from a bottom surface 140 of the housing 110 to secure the expansion battery in a stacked configuration or to raise the housing slightly off of the floor or ground. Each foot 138 includes a base 139 configured to support the expansion battery 108 when placed on a surface (not shown). Further, an arc-shaped cutout 142 is shown extending across each of the feet 138 in a direction from the front sidewall 120 to a rear sidewall 144 of the expansion battery 108. In various embodiments, the expansion battery 108 stacks on the power station 20 with the arc-shaped cutouts 142 in the feet 138 sitting securely on the oval-shaped carrying handles 34 (FIG. 1) of the power station 20. While shown as arc-shaped in FIG. 5, the cutout 142 may have a different shape in various embodiments. In many embodiments, the shape of the cutout 142 will correspond to the shape of the carrying handles 34 such that the carrying handles 34 are able to safely support the expansion battery 108.

Although FIG. 5 shows the expansion battery 108 with a specific configuration of feet 138 and cutouts 142, the expansion battery 108 may have a different number of feet 138 and/or cutouts 142 in different configurations. As a non-limiting example, expansion battery 108 may include two or six feet 138. As another non-limiting example, the expansion battery 108 may include cutouts 142 as separate components from the feet 138. As yet another non-limiting example, the cutouts 142 of the pairs of feet 138 aligned with each other in FIG. 5 and designed to sit securely on the same carrying handle 34 of the power station 20 may be connected across the bottom surface 140 of the housing 110 and considered a single cutout 142. In that case, when those pairs feet 138 are connected by the cutouts 142, the expansion battery 108 may be considered as either having four feet 138 and two cutouts 142 extending between the pairs of the feet 138 or as having two feet 138 each including one cutout 142.

Regardless of the configuration of the feet 138 and cutouts 142 of the expansion battery 108, the feet 138 and cutouts 142 are generally (though not necessarily) designed such that the expansion battery 108 stacks directly on the power station 20 with the front sidewall 48 (FIG. 1) of the power station 20 and the front sidewall 120 of the expansion battery 108 facing the same direction. This enables users to conveniently view and access the control panel 46 (FIG. 1) of the power station 20 and the display 122 (FIG. 4) of the expansion battery 108 from one location. That is, users can view and access the control panel 46 of the power station 20 and the display 122 of the expansion battery 108 without having to move to a different side of the power station 20 and/or expansion battery 108. The same is true regarding the external battery port 68 and AC and DC charging modules 70, 72 in the rear sidewall 76 (FIG. 2) of the power station 20 and the battery connection and charging module input ports 132, 134 in the rear sidewall 144 of the expansion battery 108.

Further, the engagement between the cutouts 142 of the expansion battery 108 and the carrying handles 34 of the power station 20 secures the expansion battery 108 on the power station 20 without preventing the intentional removal of the expansion battery 108 from the power station 20 by a user. That is, when the cutouts 142 of the expansion battery 108 are positioned on the carrying handles 34 of the power station 20, the expansion battery 108 cannot simply slide off of the carrying handles 34. Instead, the carrying handles 34 block the feet 138 of the expansion battery 108 from sliding over the front or rear sidewalls 48, 76 of the power station 20, and the cutouts 142 block the expansion battery 108 from sliding sideways off of the power station 20 to the left or right. Further, the cutouts 142 of the expansion battery 108 and/or the carrying handles 34 may include a non-slip surface.

Therefore, once the cutouts 142 of the expansion battery 108 are on the carrying handles 34 of the power station 20, the expansion battery 108 is protected from falling off of the power station 20 and sustaining damage. A user does not have to trigger any locks or other securing mechanisms or devices in order for this protection to take effect. Rather, a user merely has to place the cutouts 142 of the expansion battery 108 on the carrying handles 34 of the power station 20. Since a user does not have to trigger any locks when placing the expansion battery 108 on the power station 20, a user may similarly remove the expansion battery 108 from the power station 20 without the need to disengage any locks. That is, when a user no longer wants the expansion battery 108 on top of the power station 20 (for example, the expansion battery 108 has a low battery level), the user can simply lift the expansion battery 108 vertically off of the power station 20.

Referring now to FIG. 6, a rear view of the power station 20 connected to a pair of expansion batteries 146, 148 is shown, according to an embodiment of the invention. The expansion batteries 146, 148 are arranged similarly to the expansion battery 108 of FIG. 4, and thus, like elements therein are numbered identically to corresponding elements in the expansion battery 108 of FIG. 4. In FIG. 6, the external battery port 68 of the power station 20 is connected to a first expansion battery 146 and a second expansion battery 148. Each expansion battery 146, 148 may include a pair of battery connection ports 132 that connect to the power station 20 or the other expansion battery 146, 148 using a connection cable 150. Up to ten or more expansion batteries 146, 148 may be chained to the power station 20 to provide additional power. The battery system 112 of each expansion battery 146, 148 increases the battery or energy capacity (watt-hours (Wh) or joules (J)) or runtime of the power station 20. Alternatively, the expansion batteries 146, 148 could be configured to increase the running power or starting power of the power station 20. Each expansion battery 146, 148 also includes a charging module input port 134 for charging the expansion battery 146, 148.

As explained above, the control system 38 of the power station 20 is electrically coupled to the onboard battery system 36 and the external battery port 68 and may include a converter (not shown in FIG. 6) configured to convert a DC voltage to another DC voltage. As a result, the control system 38 of the power station 20 may utilize the converter to convert the DC voltage from the battery systems 112 of the expansion batteries 146, 148 into another DC voltage for distribution from the power station 20. The control system 38 of the power station 20 may additionally include a power inverter 42 to change DC power from each expansion battery 146, 148 to AC power for distribution from the power station 20. In another embodiment, the control system 114 of each expansion battery 146, 148 could provide a DC or AC power to the power station 20 that matches the requirements of any of the power output receptacles 50 of the power station 20. Accordingly, the control system 114 of each expansion battery 146, 148 may include a converter and/or inverter 152 to change DC power from the battery into an AC power supplied to the power station 20. The expansion batteries 146, 148 may also charge the onboard battery system 36 of the power station 20.

Each expansion battery 146, 148 may be paired to the power station 20 so that the control system 38 of the power station 20 can operate the expansion batteries 146, 148. Each expansion battery 146, 148 can be paired by connecting the expansion battery 146, 148 directly to the power station 20 and enabling a pairing feature on the power station 20. According to various embodiments of the invention, a user of the power station 20 may pair the expansion batteries 146, 148 to the power station 20 by performing a series of steps separately for each expansion battery 146, 148. Below is an example in which expansion battery 146 is paired to the power station 20.

In a first step, the user pairing the expansion battery 146 turns on the power station 20 and unplugs all electrical devices therefrom including any additional expansion batteries already connected and/or paired to the power station 20. In a second step, the user connects the expansion battery 146 being paired by connecting its connection cable 150 to the external battery port 68 of the power station 20. In a third step, the user holds down the overload reset button 62 (FIG. 1) of the power station 20 and presses the power button 56 (FIG. 3) of the power station 20 twice. Finally, the LED light 64 (FIG. 1) on the power station 20 will turn on and flash three times in a fourth step. If the LED light 64 does not turn on or flash three times, the user can repeat the second and third steps while ensuring that only the expansion battery 146 is connected to the power station 20. Once the expansion battery 146 is paired with the power station 20, the control system 38 of the power station 20 is able to communicate with and provide instructions to the control system 114 of the expansion battery 146.

In order to pair additional expansion batteries (for example, the expansion battery 148) to the power station 20, the user must disconnect the paired expansion battery 146 and repeat steps one through four above. Once the expansion batteries 146, 148 are paired to the power station 20, the expansion batteries 146, 148 will remain paired to the power station 20 until they are manually unpaired. In various embodiments, unpairing the expansion batteries 146, 148 may be performed by powering down or shutting down the expansion batteries 146, 148, by repeating steps one through four above, or by either method.

Pairing the expansion batteries 146, 148 allows the control system 38 of the power station 20 to discharge the battery system 36, 112 with the highest battery level before discharging the remaining batteries. In various embodiments, the battery level corresponds to a battery voltage and only the battery system or systems 36, 112 with the highest voltage will discharge until the voltage drops to approximately the same voltage level of the battery system or systems 36, 112 with the next highest battery voltage. That is, additional non-discharging battery systems 36, 112 will begin to discharge simultaneously with discharging battery systems 36, 112 when the voltages of the discharging battery systems 36, 112 approximate the voltages of the non-discharging battery systems 36, 112. In various embodiments, the voltages are approximate when the voltage levels or battery levels are within a specific percentage of each other such as 1%, 2%, 3%, 4%, or 5%, as non-limiting examples. However, in various embodiments, the voltages may be approximate when the voltage levels or battery levels are within a specific voltage level of the each other such as 1V or 2V, as non-limiting examples.

For example, the battery system 36, 112 with the highest battery level among the expansion batteries 146, 148 and the power station 20 could discharge first until the battery level is similar to the battery system 36, 112 that had the second highest battery level. The two battery systems 36, 112 will then discharge simultaneously to the level of the third highest battery level. Once all remaining battery levels are similar, each battery system 36, 112 will discharge simultaneously or at the same rate. Thus, the battery systems 112 of the expansion batteries 146, 148 may only begin discharging if their battery levels are equal to or greater than the battery level of the battery system 36 of the power station 20.

Referring now to FIGS. 7 and 8, an upper-left perspective view and a lower-right perspective view, respectively, of a stacking adaptor 158 for stacking the expansion battery 108 of FIG. 4 onto another expansion battery 108 of FIG. 4 are shown, according to an embodiment of the invention. The stacking adaptor 158 is configured to sit or snap on one of the carrying handles 116 (FIG. 4) of the expansion battery 108 such that, when two stacking adaptors 158 are positioned on the carrying handles 116 of a first expansion battery 108 (not shown in FIGS. 7 and 8), the stacking adaptors 158 provide support for a second expansion battery 108 (not shown in FIGS. 7 and 8) to stack on top of the first expansion battery 108 in a similar manner as the carrying handles 34 on the power station 20 of FIG. 1 with respect to the expansion battery 108. The stacking adaptor 158 is generally formed of a main body 158. The stacking adaptor 158 includes a lower surface 159 with one or more semicircular cutouts 160 along a length of the stacking adaptor 158. In the embodiment shown in FIGS. 7 and 8, the stacking adaptor 158 includes four semicircular cutouts 160.

However, in various embodiments, the stacking adaptor 158 has a different number of cutouts 160. As a non-limiting example, the stacking adaptor 158 may include one cutout 160 extending the entire length of the stacking adaptor 158. As another non-limiting embodiment, the stacking adaptor 158 may include two cutouts 160. Regardless of the number and configuration of the cutouts 160, each cutout 160 of the stacking adaptor 158 is configured to sit or snap on one rod-shaped carrying handle 116 of the first expansion battery 108.

The stacking adaptor 158 also includes an upper surface 161 with an oval-shaped section 162 and a flat section 164. Herein, the oval-shaped section 162 and flat section 164 of the upper surface 161 are additionally referred to as the oval-shaped upper surface 162 and the flat upper surface 164 or simply upper surfaces 162, 164. The oval-shaped upper surface 162 extends the length of the stacking adaptor 158. The upper surface 162 is configured to receive the cutouts 142 (FIG. 5) in the feet 138 (FIG. 5) of the expansion battery 108 much like the carrying handles 34 of the power stations 20. Accordingly, the stacking adaptor 158 secures the feet 138 of the second expansion battery 108 to the carrying handles 116 of the first expansion battery 108, even if the feet 138 have a geometry that fits securely on the oval-shaped carrying handles 34 of the power station 20. Although the handles 116 and feet 138 of the expansion battery 108 and the cutouts 160 of the stacking adaptor 158 are described with particular shapes or configurations, in various embodiments, other shapes or configurations may be used. However, the handles 116 of the expansion battery 108 are typically designed for the comfort of a user.

The flat upper surface 164 of the stacking adaptor 158 has two openings 166 for receiving the bases 139 of two feet 138 of one expansion battery 108. The flat upper surface 164 also includes a raised section 168 between the two openings 166. When the feet 138 of the second expansion battery 108 are positioned with the cutouts 142 on the oval-shaped upper surface 162, the bases 141 of the feet 138 are positioned in the openings 166 in the flat upper surface 164, and the raised section 168 on the flat upper surface 164 is positioned between the feet 138. This positioning of the feet 138 of the second expansion battery 108 on the upper surfaces 162, 164 of the stacking adaptor 158 aids in securing the second expansion battery 108 on the first expansion battery 108.

Regardless of the configuration of the cutouts 160 and upper surfaces 162, 164 of the stacking adaptor 58, the cutouts 160 and upper surfaces 162, 164 are generally (though not necessarily) designed such that the second expansion battery 108 stacks on the first expansion battery 108 with the front sidewalls 120 of the first and second expansion batteries 108 facing the same direction. This enables users to conveniently view and access the displays 122 of the first and second expansion batteries 108 from one location. That is, users can view and access the displays 122 of the first and second expansion batteries 108 without having to move to a different side of the first and second expansion batteries 108. This also applies to the battery connection and charging module input ports 132, 134 in the rear sidewalls 144 (FIG. 5) of the first and second expansion batteries 108.

Further, when two stacking adaptors 158 are positioned on the carrying handles 116 of the first expansion battery 108 and the second expansion battery 108 is positioned on the two stacking adaptors 158, the engagement between the cutouts 142 of the feet 138 of the second expansion battery 108 and the upper surfaces 162 of the stacking adaptors 158, the engagement between the bases 139 of the feet 138 of the second expansion battery 108 and the openings 166 in the upper surfaces 164 of the stacking adaptors 158, and the raised sections 168 of the upper surfaces 164 of the stacking adaptors 158 secure the second expansion battery 108 on the first expansion battery 108 without preventing the intentional removal of the second expansion battery 108 from the first expansion battery 108 by a user. That is, when the cutouts 160 of the stacking adaptors 158 are positioned on the carrying handles 116 of the first expansion battery 108, the stacking adaptors 158 cannot simply slide off of the carrying handles 116 of the first expansion battery 108. Instead, the carrying handles 116 block the cutouts 160 of the stacking adaptors 158 from sliding over the front or rear sidewalls 120, 144 of the first expansion battery 108, and the cutouts 160 prevent the stacking adaptors 158 from sliding sideways off of the carrying handles 116 of the first expansion battery 108 to the left or right.

Also, when the cutouts 142 of the second expansion battery 108 are positioned on the upper surfaces 162 of the stacking adaptors 158, the cutouts 142 block the second expansion battery 108 from sliding sideways off of the of the upper surfaces 162 of the stacking adaptors 158. Similarly, the engagement between the bases 139 of the feet 138 of the second expansion battery 108 and the openings 166 in the upper surfaces 164 of the stacking adaptors 158 and between the feet 138 of the second expansion battery 108 and the raised sections 168 of the upper surfaces 164 prevent the second expansion battery 108 from sliding off of the stacking adaptor 158 sideways or over the front or rear sidewalls 120, 144 of the first expansion battery 108. Further, the upper surfaces 162, 164 may include a non-slip surface to prevent the second expansion battery 108 from sliding off over the front or rear sidewalls 120, 144 of the first expansion battery 108.

Therefore, once the cutouts 160 of the two stacking adaptors 158 are on the carrying handles 116 of the first expansion battery 108 and the feet 138 of the second expansion battery 108 are on the upper surfaces 162, 164 of the stacking adaptors 158, the second expansion battery 108 is protected from falling off of the power station assembly 154 and sustaining damage. A user does not have to trigger any locks or other securing mechanisms or devices in order for this protection to take effect. Rather, a user merely has to place the cutouts 160 of the stacking adaptors 158 on the carrying handles 116 of the first expansion battery 108 and the feet 138 of the second expansion battery 108 on the upper surfaces 162, 164 of the stacking adaptors 158. Since a user does not have to trigger any locks when placing the stacking adaptors 158 and the second expansion battery 108 in the stacked configuration, a user may similarly remove the second expansion battery 108 and the stacking adaptors 158 without the need to disengage any locks. That is, when a user no longer wants the second expansion battery 108 on top of the first expansion battery 108 (for example, the second expansion battery 108 has a low battery level), the user can simply lift the second expansion battery 108 vertically off of the stacking adaptors 158. Similarly, a user can remove the stacking adaptors 158 by pulling them off of the carrying handles 116 of the first expansion battery 108.

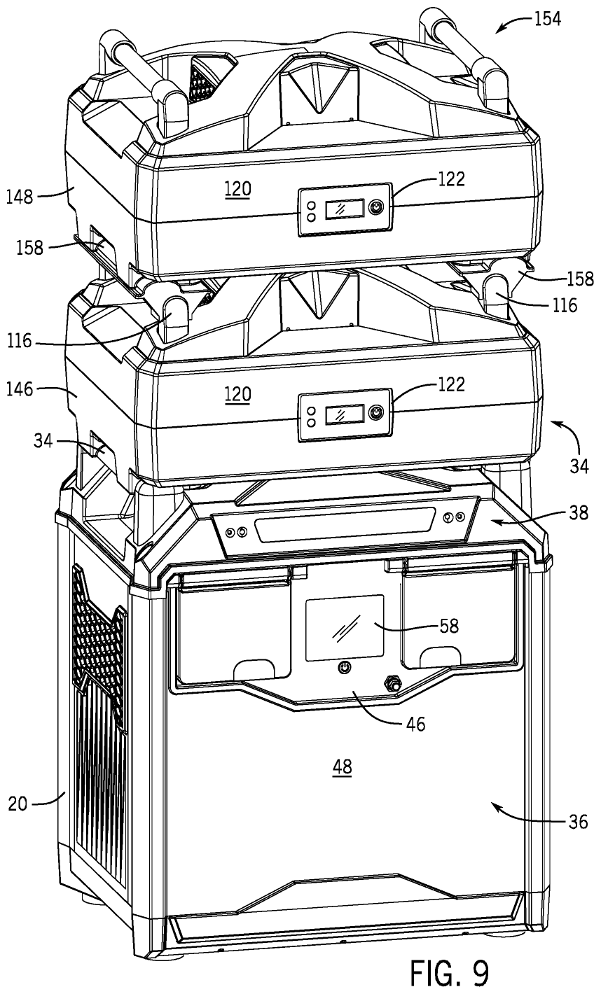

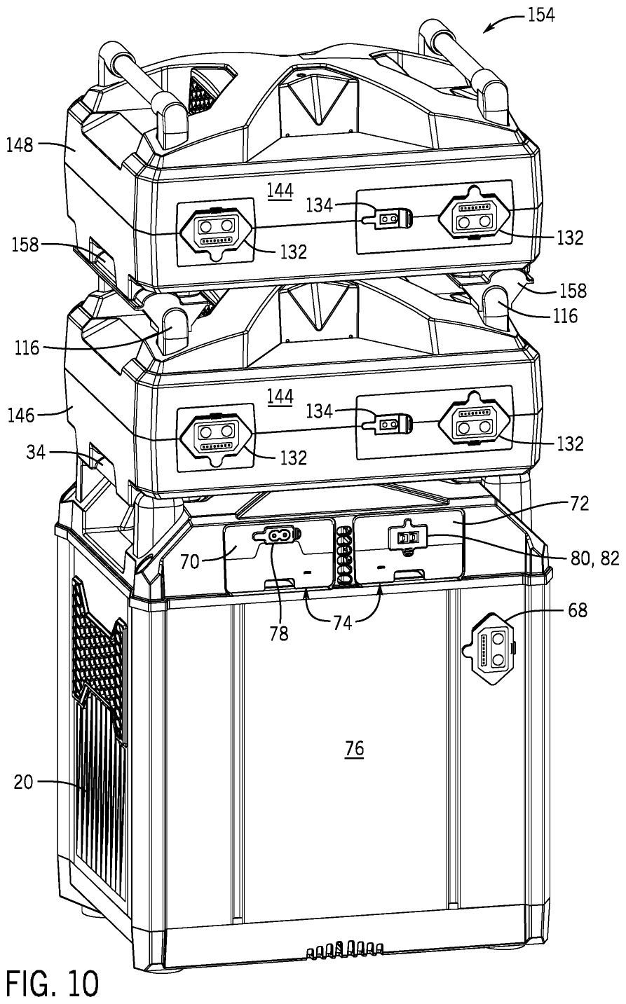

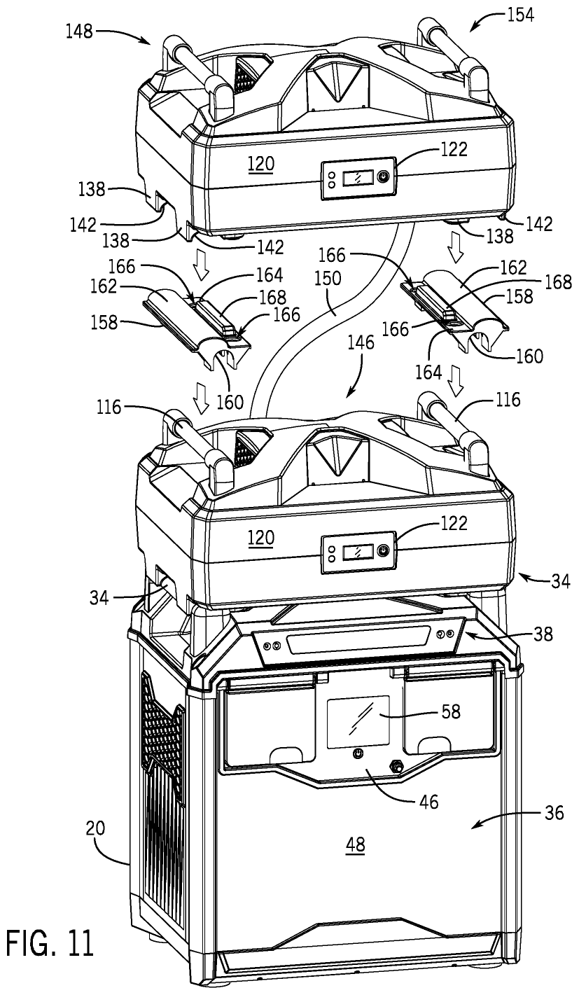

Referring now to FIGS. 9-11, a power station assembly 154 including the power station 20 and the expansion batteries 146, 148 of FIG. 6 in a stacked configuration using a pair of the stacking adaptors 158 of FIGS. 7 and 8 is shown, according to an embodiment of the invention. FIG. 9 shows an upper-left front perspective view of the power station assembly 154. FIG. 10 shows an upper-right rear perspective view of the power station assembly 154 of FIG. 9 without the connection cables 150. FIG. 11 shows an exploded view of the power station assembly 154 of FIG. 9. While FIGS. 9-11 show the power station assembly 154 with two expansion batteries 146, 148, any suitable number of expansion batteries could be stacked on the power station 20 (for example, up to ten or more). The first expansion battery 146 is stacked directly on the carrying handles 34 of the power station 20. The second expansion battery 148 is stacked on the carrying handles 116 of the first expansion battery 146 via the pair of stacking adaptors 158 sitting or snaped on the carrying handles 116 of the first expansion battery 146 to secure the second expansion battery 148 to the first expansion battery 146.

As shown, when the first and second expansion batteries 146, 148 are stacked on the power station 20, the front sidewall 48 of the power station 20 and the front sidewalls 120 of the expansion batteries 146, 148 are facing the same direction. As such, a user of the power station assembly 154 is able to view and access the control panel 46 of the power station 20 and the displays 122 of the first and second expansion batteries 146, 148 in one location. That is, a user can view and access the control panel 46 of the power station 20 and the displays 122 of the expansion batteries 146, 148 without having to move to a different side of the power station 20 and/or expansion batteries 146, 148. The same is true regarding the external battery port 68 and AC and DC charging modules 70, 72 in the rear sidewall 76 (FIG. 2) of the power station 20 and the battery connection and charging module input ports 132, 134 in the rear sidewalls 144 (FIG. 5) of the expansion batteries 146, 148. This provides the users with a convenient presentation of information and access to functionality when using the power station assembly 154.

Additionally, the engagement between the cutouts 142 of the first expansion battery 146 and the carrying handles 34 of the power station 20 secures the first expansion battery 146 on the power station 20 without preventing the intentional removal of the first expansion battery 146 from the power station 20 by a user. That is, when the cutouts 142 of the first expansion battery 146 are positioned on the carrying handles 34 of the power station 20, the first expansion battery 146 cannot simply slide off of the carrying handles 34. Instead, the carrying handles 34 block the feet 138 of the expansion battery 108 from sliding over the front or rear sidewalls 48, 76 of the power station 20 and the cutouts 142 block the first expansion battery 146 from sliding sideways off of the power station 20 to the left or right.

Therefore, once the cutouts 142 of the first expansion battery 146 are on the carrying handles 34 are on the power station 20, the first expansion battery 146 is protected from falling off of the power station 20 and sustaining damage. A user does not have to trigger any locks or other securing mechanisms or devices in order for this protection to take effect. Rather, a user merely has to place the cutouts 142 of the first expansion battery 146 on the carrying handles 34 of the power station 20. Since a user does not have to trigger any locks when placing the first expansion battery 146 on the power station 20, the user may similarly remove the first expansion battery 146 from the power station 20 without the need to disengage any locks. That is, when a user no longer wants the first expansion battery 146 on top of the power station 20 (for example, the first expansion battery 146 has a low battery level), the user can simply lift the first expansion battery 146 vertically off of the power station 20. A user may remove the second expansion battery 148 with the first expansion battery 146 or may remove the second expansion battery 148 before removing the first expansion battery 146, as desired.

As similarly explained above with respect to FIGS. 7 and 8, the stacking adaptors 158 on the carrying handles 116 of the first expansion battery 146 provide support for the second expansion battery 148 in a similar manner as the carrying handles 34 on the power station 20 with respect to the first expansion battery 146. In FIGS. 9-11, the carrying handles 116 of the first expansion battery 146 are shown with the same shape and configuration as the carrying handles 116 in FIGS. 4-6, the feet 138 of the second expansion battery 148 are shown with the same shape and configuration as the feet 138 in FIG. 5, and the stacking adaptors 158 are shown with the same shape and configuration as shown in FIGS. 7 and 8. However, as noted above, various embodiments of the carrying handles 116, the feet 138, and the stacking adaptors 158 may incorporate different shapes or configurations. Though, in general, the stacking adaptors 158 will be configured to fit on the carrying handles 116 of the first expansion battery 146 (or another expansion battery 108) and to receive the feet 138 of the second expansion battery 148 (or another expansion battery 108). In other words, regardless of the shape or configuration of the carrying handles 116, the feet 138, and the stacking adaptors 158, the stacking adaptors 158 will be configured to adapt the carrying handles 116 of the first expansion battery 146 (or another expansion battery 108) to the feet 138 of the second expansion battery 148 (or another expansion battery 108).

With specific reference to FIGS. 9-11, the lower surface 159 of each stacking adaptor 158 includes four semicircular cutouts 160 along the length of the stacking adaptor 158, and each cutout 160 of one stacking adaptor 158 sits or snaps on one rod-shaped carrying handle 116 of the first expansion battery 146. The upper surfaces 162 of each stacking adaptor 158 extend along the length of the stacking adaptors 158 and receive the cutouts 142 in the feet 138 of the second expansion battery 148 much like the carrying handles 34 of the power stations 20. Accordingly, the stacking adaptors 158 secure the feet 138 of the second expansion battery 148 to the carrying handles 116 of the first expansion battery 146, even though the feet 138 have a geometry that fits securely on the oval-shaped carrying handles 34 of the power station 20.

The flat upper surfaces 164 of each stacking adaptor 158 includes two openings 166 that receive the bases 139 of two feet 138 of the second expansion battery 148 and the raised section 168 extending between the two openings 166 and between the two feet 138 of the second expansion battery 148. The positioning of the feet 138 of the second expansion battery 148 on the upper surfaces 162, 164 of the stacking adaptors 158 enables the stacking of the first and second expansion batteries 146, 148 such that the front sidewalls 120 of the expansion batteries 146, 148 are facing the same direction, which, as explained above, allows users to conveniently view and access the displays 122 of the expansion batteries 146, 148 from one location. This also applies to the battery connection and charging module input ports 132, 134 in the rear sidewalls 144 of the expansion batteries 146, 148, as shown in FIG. 10.

The positioning of the feet 138 of the second expansion battery 148 on the upper surfaces 162, 164 of the stacking adaptors 158 also secures the second expansion battery 148 on the first expansion battery 146. That is, the engagement between the cutouts 142 of the feet 138 of the second expansion battery 148 and the upper surfaces 162 of the stacking adaptors 158, the engagement between the bases 139 of the feet 138 of the second expansion battery 148 and the openings 166 in the upper surfaces 164 of the stacking adaptors 158, and the raised sections 168 of the upper surfaces 164 of the stacking adaptors 158 secure the second expansion battery 148 on the first expansion battery 146 without preventing the intentional removal of the second expansion battery 148 from the first expansion battery 146 by a user. More specifically, with the cutouts 160 of the stacking adaptors 158 positioned on the carrying handles 116 of the first expansion battery 146, the stacking adaptors 158 cannot simply slide off of the carrying handles 116 of the first expansion battery 146. Instead, the carrying handles 116 block the cutouts 160 of the stacking adaptors 158 from sliding over the front or rear sidewalls 120, 144 of the first expansion battery 146, and the cutouts 160 prevent the stacking adaptors 158 from sliding sideways off of the carrying handles 116 of the first expansion battery 146 to the left or right.

Further, with the cutouts 142 of the second expansion battery 148 positioned on the upper surfaces 162 of the stacking adaptors 158, the cutouts 142 block the second expansion battery 148 from sliding sideways off of the of the upper surfaces 162 of the stacking adaptors 158. Similarly, the engagement between the bases 139 of the feet 138 of the second expansion battery 148 and the openings 166 in the upper surfaces 164 of the stacking adaptors 158 and between the feet 138 of the second expansion battery 148 and the raised sections 168 of the upper surfaces 164 prevent the second expansion battery 148 from sliding off of the stacking adaptor 158 sideways or over the front or rear sidewalls 120, 144 of the first expansion battery 146. Further, the upper surfaces 162, 164 may include a non-slip surface to prevent the second expansion battery 148 from sliding off over the front or rear sidewalls 120, 144 of the first expansion battery 146.

Therefore, with the cutouts 160 of the stacking adaptors 158 on the carrying handles 116 of the first expansion battery 146 and the feet 138 of the second expansion battery 148 on the upper surfaces 162, 164 of the stacking adaptors 158, the second expansion battery 148 is protected from falling off of the power station assembly 154 and sustaining damage. As similarly explained above, this configuration does not require a user to trigger any locks or other securing mechanisms or devices to start protection for the second expansion battery 148. Rather, a user merely has to place the cutouts 160 of the stacking adaptors 158 on the carrying handles 116 of the first expansion battery 146 and the feet 138 of the second expansion battery 148 on the upper surfaces 162 of the stacking adaptors 158. Since a user does not have to trigger any locks when placing stacking adaptors 158 and the second expansion battery 148 the stacked configuration, a user may similarly remove the second expansion battery 148 and the stacking adaptors 158 without the need to disengage any locks. That is, when a user no longer wants the second expansion battery 148 on top of the first expansion battery 146 (for example, the second expansion battery 148 has a low battery level), the user can simply lift the second expansion battery 148 vertically off of the stacking adaptors 158. Similarly, a user can remove the stacking adaptors 158 by pulling them off of the carrying handles 116 of the first expansion battery 146.

In addition to the stacking capabilities enabled by the configuration of power assembly 154, the control system 38 of the power station 20 may be configured to determine a number of expansion batteries 146, 148 electrically coupled to the power station 20, determine a battery level of each expansion battery 146, 148, and calculate a battery level available to the power station 20 by adding together the battery level of each expansion battery 146, 148. The control system 38 of the power station 20 may be programmed to sense each expansion battery 146, 148 coupled to the power station 20 by determining which expansion batteries 146, 148 are paired with the power station 20 and/or communicating with the control system 114 of each paired expansion battery 146, 148. The control system 38 may be programmed to determine the battery level of the battery system 112 of each expansion battery 146, 148 by reading the battery gauge 124 on each expansion battery 146, 148. The control system 38 may be programmed to add together the battery level of each expansion battery 146, 148 by adding together the percent battery level of each expansion battery 146, 148. In an alternative embodiment, the control system 38 may be configured to calculate a battery level available to the power station 20 by adding together the battery level of the onboard battery system 36 and the battery system 112 of each expansion battery 146, 148 electrically coupled to the power station 20. The automatic display 58 of the power station 20 operated by the control system 38 may display the available battery levels of the onboard battery system 36 and the battery systems 112 of the expansion batteries 146, 148.

The battery levels of the battery system 112 of each expansion battery 146, 148 electrically coupled to the power station 20 may comprise percent battery levels, and the battery level available to the power station 20 from battery system 36 and/or battery systems 112 may comprise a percent battery level relative to a capacity of the battery system 112 of a single expansion battery 146, 148 electrically coupled to the power station 20. The automatic display 58 may display the available battery level to the power station 20 as a percentage of a single expansion battery 146, 148 electrically coupled to the power station 20. That is, the automatic display 58 of the power station 20 may display that the total percent battery level is higher than 100% when the battery levels of the battery systems 112 of each expansion battery 146, 148 electrically coupled to the power station 20 have a total value greater than the capacity of the battery system 112 of a single expansion battery 146, 148. The automatic display 58 of the power station 20 may also display that the total percent battery level is higher than 100% when the battery levels of the battery system 36 of the power station 20 and each expansion battery 146, 148 electrically coupled to the power station 20 have a total value greater than the capacity of the battery system 112 of a single expansion battery 146, 148.

The control system 38 may calculate the power output and hours to empty for a particular load and operate the automatic display 58 to display the power output and/or hours to empty. The battery level available to the power station 20 is typically independent of an electrical load on the power station 20, but may be dependent on an electrical load on the power station 20 in some embodiments. Thus, the control system 38 may calculate the combined energy level of the expansion batteries 146, 148 coupled to the power station 20 independent of or dependent on an electrical load on the power output receptacles 50 (FIG. 1).

One skilled in the art will appreciate that embodiments of the invention may be interfaced to and controlled by a computer readable storage medium having stored thereon a computer program. The computer readable storage medium includes a plurality of components such as one or more of electronic components, hardware components, and/or computer software components. These components may include one or more computer readable storage media that generally stores instructions such as software, firmware and/or assembly language for performing one or more portions of one or more implementations or embodiments of a sequence. These computer readable storage media are generally non-transitory and/or tangible. Examples of such a computer readable storage medium include a recordable data storage medium of a computer and/or storage device. The computer readable storage media may employ, for example, one or more of a magnetic, electrical, optical, biological, and/or atomic data storage medium. Further, such media may take the form of, for example, floppy disks, magnetic tapes, CD-ROMs, DVD-ROMs, hard disk drives, and/or electronic memory. Other forms of non-transitory and/or tangible computer readable storage media not listed may be employed with embodiments of the invention.

A number of such components can be combined or divided in an implementation of a system. Further, such components may include a set and/or series of computer instructions written in or implemented with any of a number of programming languages, as will be appreciated by those skilled in the art. In addition, other forms of computer readable media such as a carrier wave may be employed to embody a computer data signal representing a sequence of instructions that when executed by one or more computers causes the one or more computers to perform one or more portions of one or more implementations or embodiments of a sequence.

Beneficially, embodiments of the invention provide an expandable inverter power station powered by an expandable battery system. The power station is connectable to one or more expansion batteries to obtain an increased energy capacity of the power station. The expansion batteries and the inverter power station are configured such that a user can stack the expansion batteries on the power station. The expansion batteries are also configured such that they are stackable with each other via stacking adaptors. The stacking adaptors may be positioned on the handles of a first expansion battery, and a second expansion battery may be positioned on the stacking adaptors. This stacked configuration of a power assembly with the power station and one or more expansion batteries enables a user to save space either when storing or using the power assembly.

Therefore, according to one embodiment of the invention, a stacking adaptor for power station expansion batteries incudes a main body having an upper surface and a lower surface, at least one cutout formed in the lower surface and configured to receive a handle of a first power station expansion battery, and at least one opening formed in the upper surface and configured to seat a second power station expansion battery thereon.

According to another embodiment of the invention, a power station assembly includes an inverter power station and first and second power station expansion batteries. Each of the first and second power station expansion batteries is configured to stack on the inverter power station and includes at least one handle. The power station assembly additionally includes at least one stacking adaptor configured to enable stacking of the first and second power station expansion batteries. Each stacking adaptor of the at least one stacking adaptor includes a main body. The main body includes a lower surface having at least one cutout configured to fit on each handle of the at least one handle of the first power station expansion battery one and separately fit on each handle of the at least one handle of the second power station expansion battery. The main body further includes an upper surface having at least one opening configured to seat the second power station expansion battery stacked thereon and to separately seat the first power station expansion battery stacked thereon.

According to yet another embodiment of the invention, a method of stacking expansion batteries on a power station includes positioning an inverter power station on a surface and stacking a first power station expansion battery on the inverter power station. The first power station expansion battery includes at least one handle. The method also includes positioning a separate stacking adaptor on each handle of the at least one handle of the first power station expansion battery. Each separate stacking adaptor includes a main body having a lower surface with at least one cutout positioned on a respective handle of the at least one handle of the first power station expansion battery and an upper surface with at least one opening configured to seat a second power station expansion battery stacked thereon. Furthermore, the method includes stacking the second power station expansion battery on each separate stacking adaptor.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. The singular forms ‘a’, ‘an’, and ‘the’ in the claims include plural reference unless the context clearly dictates otherwise. Additionally, while various embodiments of the invention have been described, it is to be understood that aspects of the invention may include only some of the described embodiments. Accordingly, the invention is not to be seen as limited by the foregoing description but is only limited by the scope of the appended claims.

What is claimed is:

1. A stacking adaptor for power station expansion batteries comprising:
a main body having an upper surface and a lower surface;
at least one cutout formed in the lower surface and configured to receive a handle of a first power station expansion battery; and
at least one opening formed in the upper surface and configured to seat a second power station expansion battery thereon.

2. The stacking adaptor for power station expansion batteries of claim 1 wherein the upper surface comprises:
a first section; and
a second section with a different shape from the second section.

3. The stacking adaptor for power station expansion batteries of claim 2 wherein:
the first section of the upper surface is oval-shaped; and
the second section of the upper surface is flat.

4. The stacking adaptor for power station expansion batteries of claim 1 wherein the at least one opening formed in the upper surface comprises two openings.

5. The stacking adaptor for power station expansion batteries of claim 4 further comprising a raised section extending from the upper surface between the two openings.

6. The stacking adaptor for power station expansion batteries of claim 1 wherein the at least one cutout formed in the lower surface comprises four cutouts.

7. The stacking adaptor for power station expansion batteries of claim 1 wherein the at least one cutout comprises at least one semicircular cutout.

8. A power station assembly comprising:
an inverter power station;
first and second power station expansion batteries, each of the first and second power station expansion batteries configured to stack on the inverter power station and comprising at least one handle; and
at least one stacking adaptor configured to enable stacking of the first and second power station expansion batteries, each stacking adaptor of the at least one stacking adaptor comprising a main body, the main body comprising:
a lower surface comprising at least one cutout configured to fit on each handle of the at least one handle of the first power station expansion battery one and separately fit on each handle of the at least one handle of the second power station expansion battery; and
an upper surface comprising at least one opening configured to seat the second power station expansion battery stacked thereon and to separately seat the first power station expansion battery stacked thereon.

9. The power station assembly of claim 8 wherein:
the at least one handle of the first and second power inverter expansion batteries comprises two handles; and
the at least one stacking adaptor comprises two stacking adaptors.

10. The power station assembly of claim 9 wherein the inverter power station and the first and second power station expansion batteries are configured to be positioned in a stacked configuration in which either the first power station expansion battery is stacked on the inverter power station, the two stacking adaptors are positioned on a respective handle of the two handles of the first power station expansion battery, and the second power station expansion battery is stacked on the two stacking adaptors or the second power station expansion battery is stacked on the inverter power station, the two stacking adaptors are positioned on a respective handle of the two handles of the second power station expansion battery, and the first power station expansion battery is stacked on the two stacking adaptors.

11. The power station assembly of claim 8 wherein the upper surface of each stacking adaptor of the at least one stacking adaptor comprises:
an oval-shaped section; and
a flat section.

12. The power station assembly of claim 11 wherein the at least one opening formed in the upper surface of each stacking adaptor of the at least one stacking adaptor comprises two openings formed in the flat section of the upper surface.

13. The power station assembly of claim 12 wherein:
each of the first and second power station expansion batteries comprises a plurality of feet, each foot of the plurality of feet comprising at least one base and an-arc-shaped cutout;
the arc-shaped cutout of each foot of the plurality of feet of the first and second power station expansion batteries is configured to sit on the oval-shaped section of the upper surface of each stacking adaptor of the at least one stacking adaptor; and
the at least one base of each foot of the plurality of feet of the first and second power station expansion batteries is configured to sit in the two openings formed in the flat section of the upper surface of the stacking adaptor.

14. The power station assembly of claim 12 wherein the stacking adaptor comprises a raised section formed in the flat section of the upper surface of the stacking adaptor and extending between the two openings.

15. The power station assembly of claim 8 wherein:
each handle of the at least one handle of the first and second power station expansion batteries is rod-shaped; and
each cutout of the at least one cutout of the stacking adaptor is a semicircular cutout.

16. A method of stacking expansion batteries on a power station, the method comprising:
positioning an inverter power station on a surface;
stacking a first power station expansion battery on the inverter power station, the first power station expansion battery comprising at least one handle;
positioning a separate stacking adaptor on each handle of the at least one handle of the first power station expansion battery, each separate stacking adaptor comprising a main body, the main body comprising:
a lower surface comprising at least one cutout positioned on a respective handle of the at least one handle of the first power station expansion battery; and
an upper surface comprising at least one opening configured to seat a second power station expansion battery stacked thereon; and
stacking the second power station expansion battery on each separate stacking adaptor.

17. The method of claim 16 wherein:
positioning the separate stacking adaptor on each handle of the at least one handle of the first power station expansion battery comprises:
positioning a first stacking adaptor on a first handle of the first power station expansion battery; and
positioning a second stacking adaptor on a second handle of the first power station expansion battery; and
stacking the second power station expansion battery on the first and second stacking adaptors.

18. The method of claim 16 further comprising
positioning a separate stacking adaptor on each handle of the at least one handle of the second power station expansion battery, each separate stacking adaptor comprising a main body, the main body comprising:
a lower surface comprising at least one cutout positioned on a respective handle of the at least one handle of the second power station expansion battery; and
an upper surface comprising at least one opening configured to seat a third power station expansion battery stacked thereon; and
stacking the third power station expansion battery on each separate stacking adaptor.

19. The method of claim 18 wherein:
positioning the separate stacking adaptor on each handle of the at least one handle of the second power station expansion battery comprises:
positioning a third stacking adaptor on a first handle of the second power station expansion battery; and
positioning a fourth stacking adaptor on a second handle of the second power station expansion battery; and
stacking the third power station expansion battery on the third and fourth stacking adaptors.

20. The method of claim 16 further comprising:
electrically coupling the first power station expansion battery to the inverter power station; and
electrically coupling the second power station expansion battery to the first power station expansion battery.
